(19) United States
(12) Patent Application Publication
(10) Pub. No.: US 2005/0018217 A1
(43) Pub. Date: Jan. 27, 2005

(54) Print media feeding system and method

(75) Inventor: Yen-Sung Hsieh, Taipei (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 10/846,322

(22) Filed: May 14, 2004

(30) Foreign Application Priority Data
Jul. 22, 2003 (TW) TW92119919

(51) Int. Cl. G06F 15/00; H04N 1/04

(52) U.S. Cl. 358/1.6; 358/498

(57) ABSTRACT

A print media feeding system for feeding a plurality of print media sheets. The print media feeding system includes a tray, a separator, a restricting device and a pickup roller. The tray has a first end and a second end opposite to the first end. The print media sheets are placed on the tray. The separator is disposed on the first end of the tray. The restricting device is disposed on the second end of the tray. The print media sheets are placed between the separator and restricting device. The pickup roller is disposed on the tray and rotates in a first direction and a second direction. The print media sheets placed on the tray push against the pickup roller.

### BACKGROUND OF THE INVENTION

1. Field of the Invention

The present invention relates to a print media feeding system, and in particular to a print media feeding system that precisely separates a plurality of print media sheets.

2. Description of the Related Art

A printer, fax machine or copy machine works with paper sheets. Typically the performance of a printer, fax machine or copy machine is affected by the speed with which the paper sheets are input and separated. Therefore, a print media feeding system which effectively inputs and separates paper sheets is called for.

In the aforementioned business machine (printer, fax machine or copy machine), a stack of print media sheets is transported by the print media feeding system thereof. The print media sheets may be paper sheets, transparencies, films or envelopes. Generally, the print media sheets are stacked in place on the business machine. The print media feeding system feeds the top sheet in the stack of print media sheets into the business machine. Then, the business machine performs printing, faxing or copying.

A conventional print media feeding system of a business machine generally includes a pickup roller and a sheet separator. The pickup roller transports a stack of print media sheets by means of friction between the pickup roller and the print media sheets. The sheet separator separates the print media sheets such that one print media sheet is input at a time.

Referring to FIG. 1, U.S. Pat. No. 5,971,390 discloses a first conventional feeding system 10 for a printer. The feeding system 10 includes a sheet cassette 12, a pickup assembly 14 and a separator 16. The pickup assembly 14 further includes a pickup roller 18, and the separator 16 further includes a frictional portion 19 disposed thereon. The frictional portion 19 is composed of rubber or a material with high coefficient of friction. The pickup roller 18 rolls and guides a paper sheet to the separator 16. Additionally, the feeding system 10 further includes three supporting portions 17. A stack of paper sheets is placed in the sheet cassette 12 and supported by the supporting portions 17, such that the paper sheets are not fallen out of the printer. When two paper sheets simultaneously pass through the separator 16 by transportation of the pickup roller 18, the lower paper sheet is stopped by the frictional portion 19 and remains on the separator 16. The upper paper sheet continues to enter the printing area of the printer by transportation of the pickup roller 18. Thus, one paper sheet is input to the printing area at one time.

Additionally, the pickup assembly 14 has a spring or similar resilient device (not shown) to exert a torque on the pickup roller 18, such that the pickup roller 18 presses the stack of paper sheets. Sufficient frictional force (pressing force) must be provided between the pickup roller 18 and paper sheets, such that pickup roller 18 can transport the paper sheets to the printing area via the separator 16. Namely, the friction between the pickup roller 18 and paper sheets must be greater than that between the paper sheets and separator 16.

In order to successfully advance the paper sheets to the printing area of the printer from the sheet cassette 12, three parameters of the pickup assembly 14 must be accurately controlled. The three parameters are the vertical distance h between the pickup roller 18 and separator 16, the horizontal distance w between the pickup roller 18 and separator 16 and the material of the separator 16. The vertical distance h between the pickup roller 18 and separator 16 is relative to the normal force exerted by the pickup roller 18. The normal force further affects the friction between the pickup roller 18 and paper sheet. The horizontal distance w between the pickup roller 18 and separator 16 is relative to buckling between the paper sheet and separator 16. The material of the separator 16 affects the friction between the separator 16 and paper sheet. Accordingly, the performance of the feeding system 10 is affected by the aforementioned parameters, and the aforementioned parameters are not easily controlled.

Referring to FIG. 2, a second conventional feeding system 20 includes a sheet cassette 22, a separator 26 and a pickup roller 28. The separator 26 is composed of rubber or a material with high coefficient of friction. A spring 24 is disposed under the separator 26 to exert a normal force F thereon. Another spring 29 is disposed under the sheet cassette 22.

When the feeding system 20 operates, the sheet cassette 22 containing paper sheets is pushed upward by the spring 29 disposed thereunder. The pickup roller 28 contacts the paper sheets and guides them to a printing area. When two paper sheets simultaneously pass through the separator 26, the bottom paper sheet is stopped by the friction provided by the separator 26 and remains thereon. The top paper sheet is transported by the pickup roller 28 into the printing area. The feeding system 20 performs sheet separation by means of the friction between two paper sheets smaller than that between the paper sheet and pickup roller 28. In addition, the friction between the paper sheet and pickup roller 28 is greater than that between the paper sheet and separator 26.

Accordingly, in order to exactly separate the paper sheets, a few parameters of the feeding system 20 must be accurately controlled. Namely, the angle α and normal force F (compression force provided by the spring 24) between the pickup roller 28 and separator 26 must be accurately controlled, and the material of the separator 26 must be carefully selected as the aforementioned parameters are difficult to control. Moreover, if accurate control over the parameters is maintained, the pickup roller 28 would probably guide more than one paper sheet to the printing area at a time even when one paper sheet is stopped by the separator 26. Additionally, the stability of exact sheet separation is reduced due to wear of the separator 26.

Referring to FIG. 3A and FIG. 3B, a third conventional feeding system 30 includes a sheet cassette 31, a spring 34, two snubbers 36 and two pickup rollers 38. The pickup rollers 38 are disposed on the sheet cassette 31. The spring 34 is disposed under the sheet cassette 31 to exert normal force on the bottom of sheet cassette 31, such that the pickup rollers 38 push against paper sheets 32 on the sheet cassette 31. The two snubbers 36 are respectively disposed on opposite ends of the front edge of the sheet cassette 31.

As shown in FIG. 3B, when the pickup rollers 38 guide a paper sheet 32 to a printing area, the leading edge of the paper sheet 32 buckles due to obstruction by the snubbers 36. Namely, when two paper sheets 32 are simultaneously transported by the pickup rollers 38, the top paper sheet warps at the snubbers 36 and then bounces off the snubbers 36 due to transportation of the friction provided by the pickup rollers 38. Thus, the top paper sheet is separated from the lower paper sheet.

The sheet separation of the feeding system 30 is affected by the buckling distance S and is thereby unstable. Specifically, when the buckling distance S is small and rigidity of the paper sheet (such as a photograph) is great, the leading edge of the paper sheet is easily damaged due to the obstruction. However, when the buckling distance S is large and the paper sheet is less rigid, the leading edge thereof becomes wrinkled and the paper sheet is completely damaged as a result. Thus, adjustment of the buckling distance S is critical, particularly when the rigidity difference between the paper sheets is great. Although the buckling distance S may be adjusted to a preferable value, the range of rigidity of the paper sheets used by the feeding system 30 or business machine is limited.

### SUMMARY OF THE INVENTION

Accordingly, an object of the invention is to provide an improved print media feeding system to overcome the aforementioned problems such as reduced normal force (or fatigue of the spring) between the pickup roller and separator, wear of the separator, and variations of buckling distance due to different types of paper sheets. The present print media feeding system accepts a wide range of print media sheets with different levels of rigidity, and precisely separates the print media sheets. The print media feeding system for feeding a plurality of print media sheets comprises a tray, a separator, a restricting device and a pickup roller. The tray has a first end and a second end opposite to the first end. The print media sheets are placed on the tray. The separator is disposed on the first end of the tray. The restricting device is disposed on the second end of the tray. The print media sheets are placed between the separator and restricting device. The pickup roller is disposed on the tray and rotates in a first direction and a second direction. The print media sheets placed on the tray push against the pickup roller.

Preferably, the print media feeding system further comprises a resilient element disposed under the tray to exert a resilient force to the tray. The print media sheets on the tray push against the pickup roller by means of the resilient force.

Preferably, the separator further comprises a first receiving portion and a first surface formed on the first receiving portion. The leading edges of the print media sheets are received in the first receiving portion.

Preferably, the first surface is a frictional surface.

Preferably, the first surface is composed of rubber.

Preferably, the restricting device further comprises a second receiving portion to receive the rear edges of the print media sheets.

Preferably, the restricting device further comprises a second surface formed in the second receiving portion. The second surface is a frictional surface.

Preferably, the second surface is composed of rubber.

Preferably, the second surface is saw-toothed.

Preferably, the restricting device further comprises a retardant portion formed on the second receiving portion.

Preferably, the tray is curved such that the print media sheets placed thereon are curved.

Preferably, the pickup roller is adjacent to the separator.

Preferably, the pickup roller is composed of rubber.

Preferably, the resilient element is a spring.

Preferably, the print media feeding system further comprises a transmission device and a motor connected to the transmission device. The transmission device is connected to the pickup roller.

Preferably, the print media sheets are paper sheets, transparencies, film, photographic paper sheets or envelopes.

Another object of the invention is to provide a print media feeding method using the print media feeding system. The print media feeding method comprises the steps of placing a plurality of print media sheets on the tray and in the separator and restricting device, wherein the print media sheets push against the pickup roller; rotating the pickup roller in a first direction such that first of the print media sheets buckles between the separator and restricting device and slides out of the separator; and rotating the pickup roller in a second direction such that the first of the print media sheets slides out of the restricting device and print media feeding system, wherein the first direction is opposite to the second direction.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a perspective view showing a first conventional feeding system;

FIG. 2 is a schematic side view showing a second conventional feeding system;

FIG. 3A is a schematic top view showing a third conventional feeding system;

FIG. 3B is a partial side view according to FIG. 3A;

FIG. 4 is a schematic side view showing the print media feeding system of the invention;

FIG. 5 is a schematic side view showing the separator of the print media feeding system of the invention;

FIG. 6A is a schematic side view showing the first restricting device of the print media feeding system of the invention;

FIG. 6B is a schematic side view showing the second restricting device of the print media feeding system of the invention;

FIG. 6C is a schematic side view showing the third restricting device of the print media feeding system of the invention;

FIG. 7A is a schematic side view showing the operation of the print media feeding system of the invention;

FIG. 7B is a partial enlarged view according to FIG. 7A;

FIG. 8A is a schematic side view showing the operation of the print media feeding system of the invention; and

FIG. 8B is a partial enlarged view according to FIG. 8A.

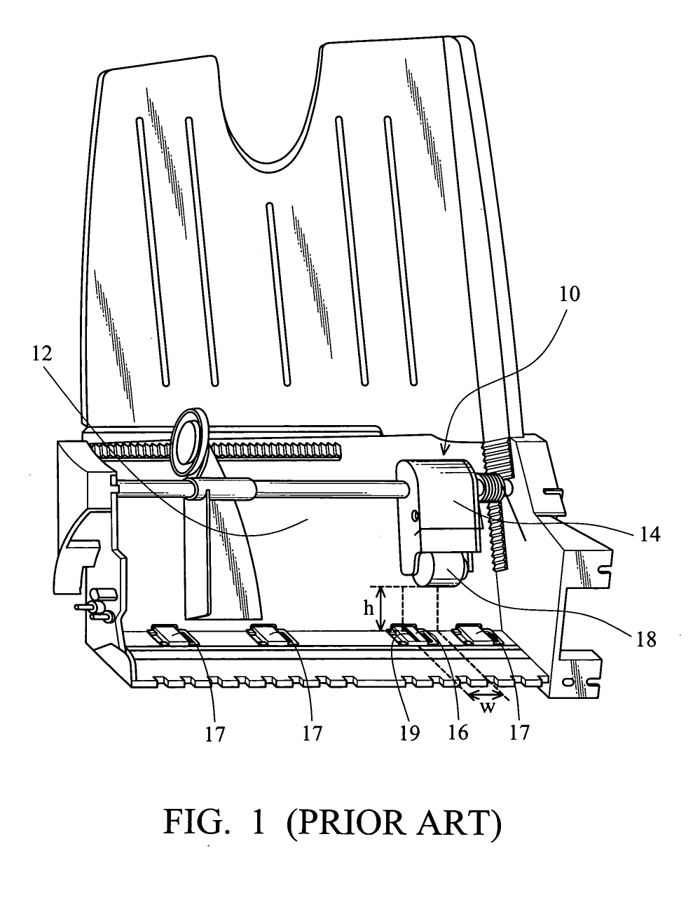

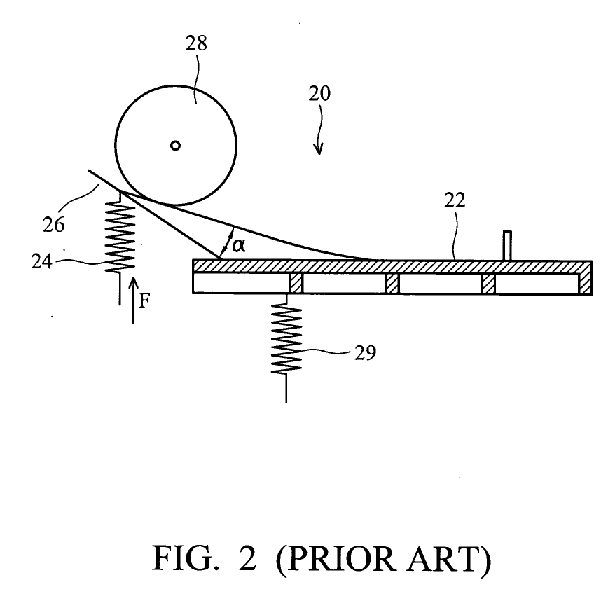

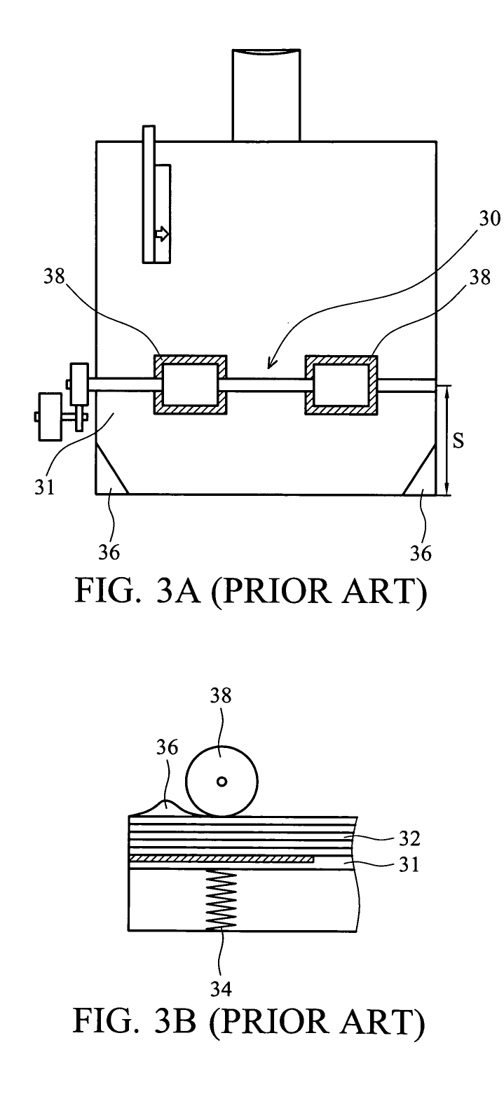

### DETAILED DESCRIPTION OF THE INVENTION

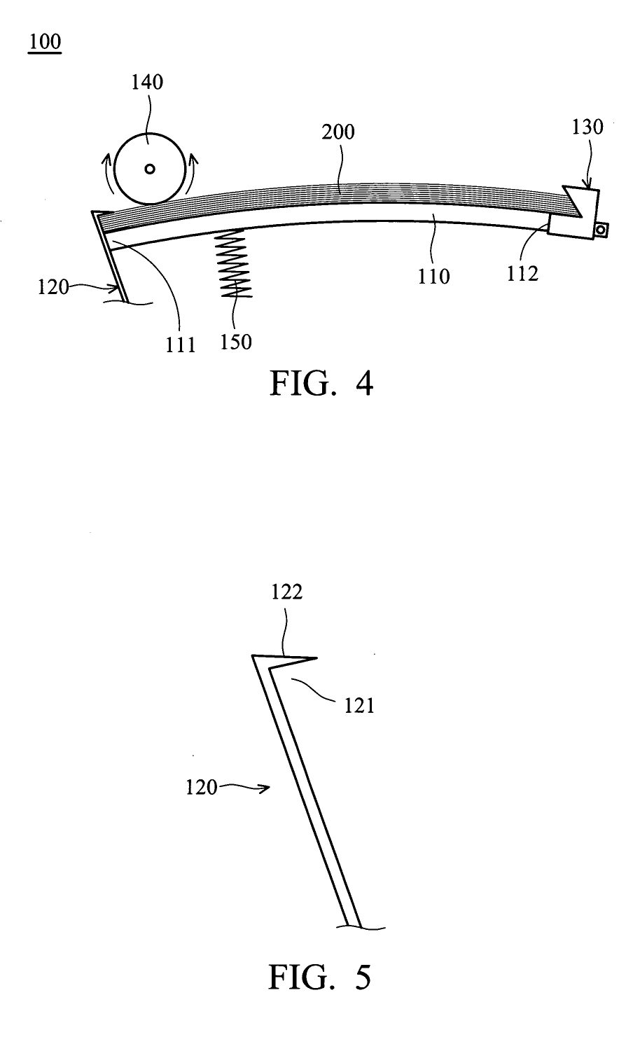

Referring to FIG. 4, the print media feeding system 100 guides and transports a plurality of print media sheets 200, such as paper sheets, transparencies, films, photographic paper sheets or envelopes, to a business machine. The print media feeding system 100 includes a tray 110, a separator 120, a restricting device 130, a pickup roller 140 and a resilient element 150. Additionally, the print media feeding system 100 includes a transmission device (not shown) and a motor (not shown) connected to the transmission device. The transmission device is connected to the pickup roller 140 to activate the pickup roller 140.

As shown in FIG. 4, the tray 110 has a first end 111 and a second end 112 opposite to the first end 111. Meanwhile, the tray 110 is curved such that the print media sheets 200 placed thereon are thereby curved.

The separator 120 is disposed on the first end 111 of the tray 110, and the restricting device 130 is disposed on the second end 112 of the tray 110. When the print media sheets 200 are placed on the tray 110, the print media sheets 200 are located between the separator 120 and restricting device 130. Specifically, the leading edges of the print media sheets 200 are received in the separator 120, and the rear edges thereof are received in the restricting device 130.

The pickup roller 140 is disposed on the tray 110. The pickup roller 140 is adjacent or close to the separator 120. The pickup roller 140 can rotate in a first direction (counterclockwise) and a second direction (clockwise). Additionally, the pickup roller 140 is composed of rubber.

The resilient element 150 is disposed under the tray 110 to exert a resilient force to the tray 110. Thus, the print media sheets 200 placed on the tray 110 push against the pickup roller 140 by means of the resilient force provided by the resilient element 150.

Referring to FIG. 5, the separator 120 has a first receiving portion 121 and a first surface 122 formed on the first receiving portion 121. Additionally, the first surface 122 is a frictional surface composed of rubber. Accordingly, when the print media sheets 200 are placed on the tray 110, the leading edges of the print media sheets 200 are received in the first receiving portion 121 of the separator 120.

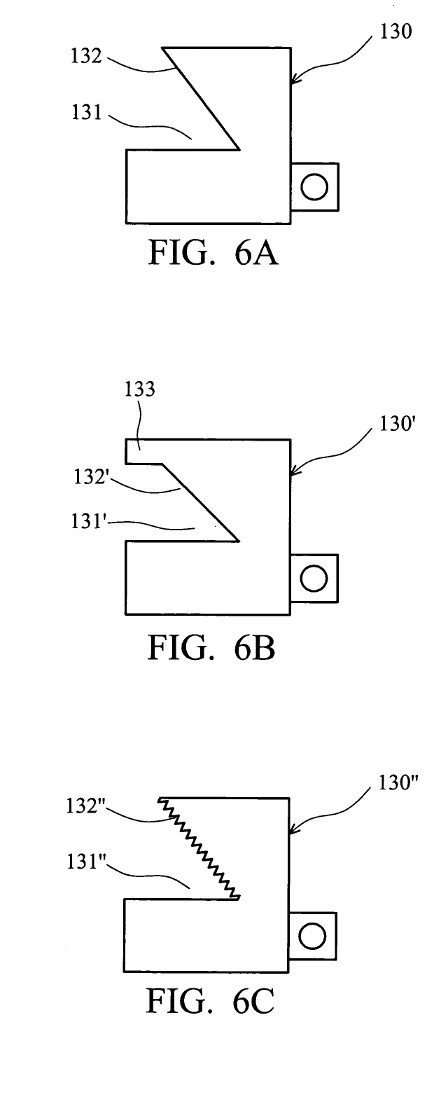

Referring to FIG. 6A, the restricting device 130 has a second receiving portion 131 and a second surface 132 formed in the second receiving portion 131. Additionally, the second surface 132 is also a frictional surface composed of rubber. Accordingly, when the print media sheets 200 are placed on the tray 110, the rear edges of the print media sheets 200 are received in the second receiving portion 131 of the restricting device 130 and held by the second surface 132 thereof. Specifically, the rear edges of the print media sheets 200 are held on the second surface 132 by means of friction provide by the second surface 132.

Specifically, the restricting device 130 is not limited to the shape as shown in FIG. 6A. The restricting device 130 may have the shape as shown in FIG. 6B or FIG. 6C.

Referring to FIG. 6B, the restricting device 130′ has a second receiving portion 131′, a second surface 132′ and a retardant portion 133. The second surface 132′ is formed in the second receiving portion 131′, and the retardant portion 133 is formed on the second receiving portion 131′. Similarly, the second surface 132′ of the restricting device 130′ is a frictional surface composed of rubber. Accordingly, when the rear edges of the print media sheets 200 are received in the second receiving portion 131′ of the restricting device 130′, the rear edges of the print media sheets 200 are held by the second surface 132′ thereof and located under the retardant portion 133 thereof. Thus, the rear edges of the print media sheets 200 are held on the second surface 132′ by means of friction provided thereby and retardation of the retardant portion 133.

Referring to FIG. 6C, the second surface 132″of the restricting device 130″ has a saw-toothed shape to provide proper friction to the rear edges of the print media sheets 200. The rear edges of the print media sheets 200 are thereby held on the second surface 132″.

The following description explains the operation of the print media feeding system 100.

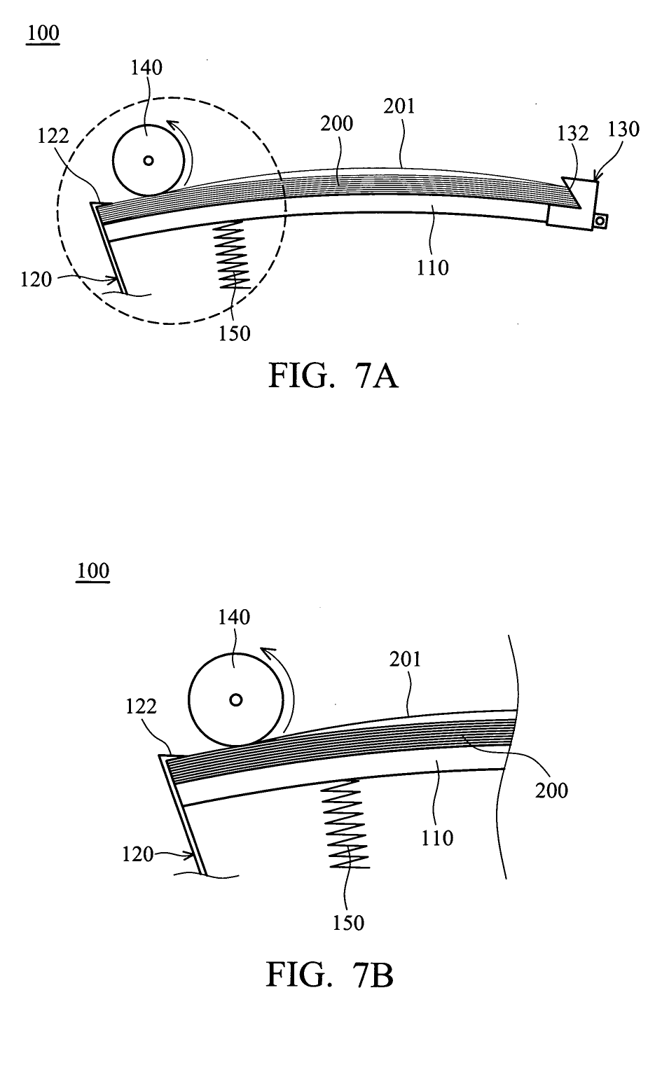

Referring to FIG. 7A and FIG. 7B, when the print media feeding system 100 guides and transports a first print media sheet 20.1 of the print media sheets 200, the pickup roller 140 rotates in a first direction (counterclockwise) to move the first print media sheet 201 toward the restricting device 130 with a small distance. Because the rear edge of the first print media sheet 201 is retarded by the second surface 132 of the restricting device 130, the first print media sheet 201 is completely buckled. At this time, the leading edge of the first print media sheet 201 slides smoothly out of the separator 120. The tray 110 is pushed upward by the resilient element 150, such that the remaining print media sheets 200 on the tray 110 push against the separator 120. Specifically, the separator 120 does not obstruct and cause buckling of the print media sheets 200 or the first print media sheet 201. The separator 120 fixes the leading edges of the print media sheets 200 in a predetermined position and separates the first print media sheet 201 from the remaining print media sheets 200.

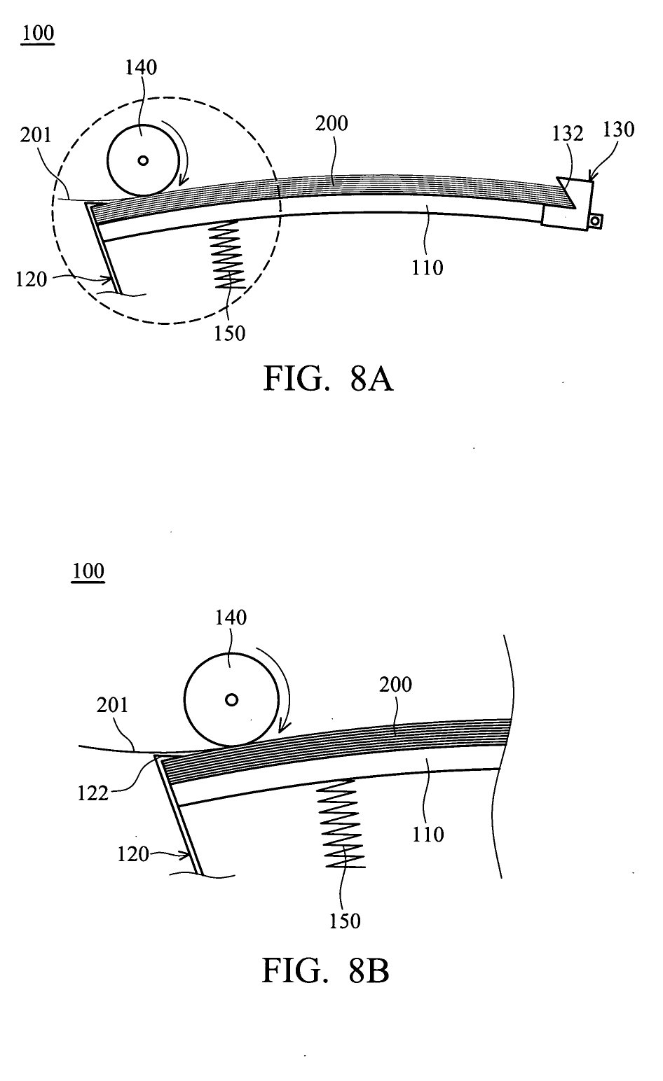

Referring to FIG. 8A and FIG. 8B, the pickup roller 140 then rotates in a second direction (clockwise) to move the first print media sheet 201 out of the print media feeding system 100. At this time, the first print media sheet 201 passes through the first surface 122 of the separator 120. Specifically, because of pushing of the resilient element 150, a sufficient normal force is created between the tray 110 and pickup roller 140. The friction between the pickup roller 140 and first print media sheet 201 must be greater than that between the first print media sheet 201 and first surface 122 of the separator 120, such that the first print media sheet 201 can smoothly pass through the first surface 122 of the separator 120 and be guided out.

In addition, the friction between two print media sheets 200 is smaller than that between a print media sheet 200 and the pickup roller 140. Thus, when two (or more) print media sheets 200 are unexpectedly and simultaneously transported by the pickup roller 140, the bottom print media sheet 200 is stopped by the first surface 122 of the separator 120, and the top print media sheet 200 continues to be transported by the pickup roller 140.

In conclusion, the print media feeding system 100 of the invention has the following advantages. Since the tray 110 is curved, the print media sheets 200 placed thereon are curved in advance. When the pickup roller 140 rotates in the first direction (counterclockwise), the first print media sheet 201 is easily buckled in a predetermined direction. Since the buckling distance of first print media sheet 201 between the pickup roller 140 and the restricting device 130 is large, the sensitivity of rigidity of the first print media sheet 201 is reduced. Namely, the print media feeding system 100 can be used with print media sheets with different rigidity properties. Thus, the business machine using the print media feeding system 100 can accept a wide range of print media sheets. Additionally, the structure of the print media feeding system 100 is simplified. Furthermore, the print media feeding system 100 does not require complex parameter control, and can easily and exactly separate the print media sheets.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A print media feeding system for feeding a plurality of print media sheets, comprising:
a tray having a first end and a second end opposite to the first end, the plurality of print media sheets placed on the tray;
a separator disposed on the first end of the tray;
a restricting device disposed on the second end of the tray, the plurality of print media sheets placed between the separator and restricting device; and
a pickup roller disposed on the tray and rotating in a first direction and a second direction, the plurality of print media sheets placed on the tray pushing against the pickup roller.

2. The print media feeding system as claimed in claim 1, further comprising a resilient element disposed under the tray to exert a resilient force to the tray, wherein the print media sheets on the tray push against the pickup roller by means of the resilient force.

3. The print media feeding system as claimed in claim 1, wherein the separator further comprises a first receiving portion and a first surface formed on the first receiving portion, the leading edges of the print media sheets received in the first receiving portion.

4. The print media feeding system as claimed in claim 3, wherein the first surface is a frictional surface.

5. The print media feeding system as claimed in claim 3, wherein the first surface is composed of rubber.

6. The print media feeding system as claimed in claim 1, wherein the restricting device further comprises a second receiving portion to receive the rear edges of the print media sheets.

7. The print media feeding system as claimed in claim 6, wherein the restricting device further comprises a second surface formed in the second receiving portion, the second surface being a frictional surface.

8. The print media feeding system as claimed in claim 7, wherein the second surface is composed of rubber.

9. The print media feeding system as claimed in claim 7, wherein the second surface is saw-toothed.

10. The print media feeding system as claimed in claim 6, wherein the restricting device further comprises a retardant portion formed on the second receiving portion.

11. The print media feeding system as claimed in claim 1, wherein the tray is curved such that the print media sheets placed thereon are curved.

12. The print media feeding system as claimed in claim 1, wherein the pickup roller is adjacent to the separator.

13. The print media feeding system as claimed in claim 12, wherein the pickup roller is composed of rubber.

14. The print media feeding system as claimed in claim 2, wherein the resilient element is a spring.

15. The print media feeding system as claimed in claim 1, further comprising a transmission device and a motor connected to the transmission device, the transmission device connected to the pickup roller.

16. The print media feeding system as claimed in claim 1, wherein the print media sheets are paper sheets, transparencies, film, photographic paper sheets or envelopes.

17. A print media feeding method for a print media feeding system having a tray, a separator, a restricting device, a pickup roller and a resilient element, the tray having a first end and a second end opposite to the first end, the separator disposed on the first end of the tray, the restricting device disposed on the second end of the tray, the pickup roller disposed on the tray, the method comprising the steps of:
placing a plurality of print media sheets on the tray and in the separator and restricting device, wherein the print media sheets push against the pickup roller;
rotating the pickup roller in a first direction such that first of the print media sheets buckles between the separator and restricting device and slides out of the separator; and
rotating the pickup roller in a second direction such that the first of the print media sheets slides out of the restricting device and print media feeding system, wherein the first direction is opposite to the second direction.

18. The print media feeding method as claimed in claim 17, wherein the print media feeding system further comprises a resilient element disposed under the tray to exert a resilient force to the tray, the print media sheets on the tray pushing against the pickup roller by means of the resilient force.

19. The print media feeding method as claimed in claim 17, wherein the pickup roller is adjacent to the separator.

20. The print media feeding method as claimed in claim 17, wherein the print media sheets are paper sheets, transparencies, film, photographic paper sheets or envelopes.
